(19) United States
(12) Patent Application Publication
(10) Pub. No.: US 2002/0028901 A1
(43) Pub. Date: Mar. 7, 2002

(54) Siloxane-containing polyurethane-urea compositions

(75) Inventors: Pathiraja A. Gunatillake, Victoria (AU); Simon John McCarthy, Portland, OR (US); Raju Adhikari, Victoria (AU); Gordon Francis Meijs, Victoria (AU)

Correspondence Address: Schwegman, Lundberg, Woessner & Kluth, P.A., P.O. Box 2938, Minneapolis, MN, 55402, US

(73) Assignee: ELASTOMEDIC PTY LIMITED

(21) Appl. No.: 09/933,938

(22) Filed: Aug. 21, 2001

Related U.S. Application Data
(63) Continuation of application No. PCT/AU00/00345, filed on Apr. 19, 2000.

(30) Foreign Application Priority Data
Apr. 23, 1999 (AU) PP9917

(51) Int. Cl. C08G 18/32; C08G 18/38; C08G 18/61; C08G 18/48; C08G 18/42; C08G 18/44

(52) U.S. Cl. 528/28; 528/31; 528/32; 528/33; 528/35; 528/38

(57) ABSTRACT

An improved biostable polyurethane-urea elastomeric composition derived from a silicon-containing diamine of formula (I).

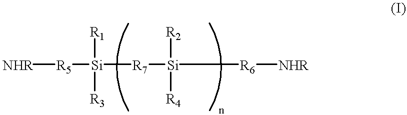

The present invention relates to siloxane-containing polyurethane-urea elastomeric compositions having improved properties. These polyurethane-urea compositions are useful for a variety of applications including the manufacture of medical devices, articles or implants which contact living tissues or bodily fluids, in particular applications which require materials to withstand cyclic flex fatigue.

Polyurethane elastomers are amongst the best performing synthetic polymers in medical implant applications. Their excellent mechanical properties coupled with relatively good biostability make them the choice materials for a number of medical implants including cardiac pacemakers, catheters, implantable prostheses, cardiac assist devices, heart valves and vascular grafts. The excellent mechanical properties of polyurethane elastomers are attributed to their two-phase morphology resulting from microphase separation of soft and hard segments.

Most polyurethane elastomers are prepared by reacting three basic components, a long chain polyether or polyester polyol, which forms the “soft” segment of the polyurethane and a diisocyanate and glycol chain extender which in combination forms the “hard” segment. In a typical polyurethane elastomer, these components are linked via urethane (—NHCOO—) linkages. However, if the chain extender is a diamine or the soft segment forming component consists of amine end groups, the resulting polyurethane structure contains both urethane and urea (—NHCONH—) linkages. Such polymers are commonly referred to as polyurethane-ureas. The polyurethane-urea structure as compared to the polyurethane structure, generally leads to improved mechanical properties, especially higher heat stability of the polymers. Of particular significance are the improvements in elasticity, ultimate tensile strength, tear and abrasion resistance and resistance to flex fatigue. Polyurethane-ureas also exhibit very low stress relaxation (low material creep).

Biomer® is a commercial polyurethane-urea elastomer which has been widely tested for medical implant applications. This elastomer is based on poly(tetramethylene oxide) (PTMO), 4,4′-methylenediphenyldiisocyanate and a mixture of diamine chain extenders with ethylenediamine being the major component. Generally, polyurethane-ureas based on PTMO exhibit excellent mechanical properties. However, these polyurethane-ureas when implanted for long periods of time, biodegrade causing surface or deep cracking, stiffening, erosion or the deterioration of mechanical properties such as flexural strength^{1,2,3}. It is generally accepted that the degradation is primarily an in vivo oxidation process involving the PTMO soft segment. In PTMO-based materials, the most vulnerable site for degradation is the methylene group alpha to the ether oxygen² of the soft segment. Accordingly, PTMO based polyurethane-urea compositions have poor biostability.

Most of the known polyurethane-urea compositions are based on PTMO. For example, biomedical polyurethane-ureas such as Biomer, Mitrathane, Unithane, Surethane and Haemothane are all based on MDI, PTMO and EDA. The stability of these materials in long-term implant applications is expected to be very poor primarily due to the PTMO based soft segment which has been shown to be prone to degradation^{2,4}.

Polysiloxane-based materials, especially polydimethyl siloxane (PDMS) exhibit characteristics such as low glass transition temperatures, good thermal, oxidative and hydrolytic stabilities, low surface energy, good haemocompatibility and low toxicity. They also display an improved ability to be bonded to silicone components, by such procedures as gluing, solvent welding, coextrusion or comolding. For these reasons PDMS has been used in biomedical applications. However, PDMS-based polymers generally have limitations and do not exhibit the necessary combination of tear resistance, abrasion resistance and tensile properties for many types of implants intended for long term use. It would be desirable for polymers to be available with the stability and biological properties of PDMS, but the strength, abrasion resistance, processability and other physical properties of polyurethane-ureas.

A requirement accordingly exists to develop siloxane-containing polyurethane-urea compositions having improved biostability. Such polyurethane-urea compositions would be a useful addition to the range of biostable polyurethanes developed recently in International Patent Application Nos. PCT/AU97/00919 and PCT/AU98/00546 and in U.S. Pat. No. 5,393,858. Improvement in degradation resistance combined with the typically high tear strength and flex-fatigue resistance of polyurethane-ureas make such materials suitable for a variety of medical implant applications. Particular examples include vascular grafts, heart valves, diaphragms for blood pumps and components for ventricular assist devices.

According to one aspect of the present invention there is provided a polyurethane-urea elastomeric composition which is derived from a silicon-containing diamine of the formula (I):

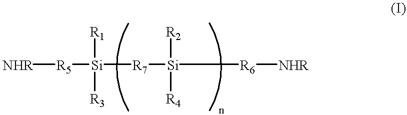

wherein

R is hydrogen or an optionally substituted straight chain, branched or cyclic, saturated or unsaturated hydrocarbon radical;

R₁, R₂, R₃, R₄, R₅ and R₆ are the same or different and selected from hydrogen or an optionally substituted straight chain, branched or cyclic, saturated or unsaturated hydrocarbon radical;

R₇ is a divalent linking group or an optionally substituted straight chain, branched or cyclic, saturated or unsaturated hydrocarbon radical; and

n is an integer of 1 or greater.

According to another aspect of the present invention there is provided use of the diamine of the formula (I) defined above in producing a polyurethane-urea elastomeric composition.

According to a further aspect of the present invention there is provided the diamine of the formula (I) defined above when used in producing a polyurethane-urea elastomeric composition.

The diamine of the formula (I) will function as chain extender when n is a lower integer such as 1 to 4 for molecular weights of about 500 or less and as a macrodiamine to form the soft segment of a polyurethane-urea composition when n is a higher integer such as 5 to 100 for molecular weights of about 500 to about 10,000. It may also be used in combination with known chain extenders, macrodiols and macrodiamines.

The present invention also provides a chain extender including the diamine of the formula (I) defined above.

The present invention further provides use of the diamine of the formula (I) defined above as a chain extender.

The present invention still further provides the diamine of the formula (I) defined above when used as a chain extender.

The term “chain extender” in the present context means any compound having at least two functional groups per molecule capable of reacting with the isocyanate group and generally in the molecular weight range 15 to about 500, more preferably 60 to about 450.

The present invention also provides a soft segment of a polyurethane-urea elastomeric composition derived from the diamine of the formula (I) defined above.

The present invention further provides use of the diamine of the formula (I) defined above in producing the soft segment of a polyurethane-urea elastomeric composition.

The present invention still further provides the diamine of the formula (I) defined above when used in producing the soft segment of a polyurethane-urea elastomeric composition.

The hydrocarbon radical for substituents R, R₁, R₂, R₃ and R₄ may include alkyl, alkenyl, alkynyl, aryl or heterocyclyl radicals. It will be appreciated that the equivalent radicals may be used for substituents R₅, R₆ and R₇ except that the reference to alkyl, alkenyl and alkynyl should be to alkylene, alkenylene and alkynylene, respectively. In order to avoid repetition, only detailed definitions of alkyl, alkenyl and alkynyl are provided hereinafter.

The term “alkyl” denotes straight chain, branched or mono- or poly-cyclic alkyl, preferably C₁₋₁₂ alkyl or cycloalkyl. Examples of straight chain and branched alkyl include methyl, ethyl, propyl, isopropyl, butyl, isobutyl, sec-butyl, amyl, isoamyl, sec-amyl, 1,2-dimethylpropyl, 1,1-dimethylpropyl, pentyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1,2-pentylheptyl and the like. Examples of cyclic alkyl include cyclopropyl, cyclobutyl, cyclopentyl, cyclohexyl, cycloheptyl, cyclooctyl, cyclononyl, cyclodecyl and the like.

The term “alkenyl” denotes groups formed from straight chain, branched or mono- or poly-cyclic alkenes including ethylenically mono- or poly-unsaturated alkyl or cycloalkyl groups as defined above, preferably C₂₋₁₂ alkenyl. Examples of alkenyl include vinyl, allyl, 1-methylvinyl, butenyl, iso-butenyl, 3-methyl-2-butenyl, 1-pentenyl, cyclopentenyl, 1-methyl-cyclopentenyl, 1-hexenyl, 3-hexenyl, cyclohexenyl, 1-heptenyl, 3 heptenyl, 1-octenyl, cyclooctenyl, 1-nonenyl, 2-nonenyl, 3-nonenyl, 1-decenyl, 3-decenyl, 1,3-butadienyl, 1,4-pentadienyl, 1,3-cyclopentadienyl, 1,3-hexadienyl, 1,4-hexadienyl, 1,3-cyclohexadienyl, 1,4-cyclohexadienyl, 1,3-cycloheptadienyl, 1,3,5-cycloheptatrienyl, 1,3,5,7-cycloocta-tetraenyl and the like.

The term “alkynyl” denotes groups formed from straight chain, branched, or mono- or poly-cyclic alkynes. Examples of alkynyl include ethynyl, 1-propynyl, 1-and 2-butynyl, 2-methyl-2-propynyl, 2-pentynyl, 3-pentynyl, 4-pentynyl, 2-hexynyl, 3-hexynyl, 4-hexynyl, 5-hexynyl, 10-undecynyl, 4-ethyl-1-octyn-3-yl, 7-dodecynyl, 9-dodecynyl, 10-dodecynyl, 3-methyl-1-dodecyn-3-yl, 2-tridecynyl, 11-tridecynyl, 3-tetradecynyl, 7-hexadecynyl, 3-octadecynyl and the like.

The term “aryl” denotes single, polynuclear, conjugated and fused residues of aromatic hydrocarbons. Examples of aryl include phenyl, biphenyl, terphenyl, quaterphenyl, phenoxyphenyl, naphthyl, tetrahydronaphthyl, anthracenyl, dihydroanthracenyl, benzanthracenyl, dibenzanthracenyl, phenanthrenyl and the like.

The term “heterocyclyl” denotes mono- or poly-cyclic heterocyclyl groups containing at least one heteroatom selected from nitrogen, sulphur and oxygen. Suitable heterocyclyl groups include N-containing heterocyclic groups, such as, unsaturated 3 to 6 membered heteromonocyclic groups containing 1 to 4 nitrogen atoms, for example, pyrrolyl, pyrrolinyl, imidazolyl, pyrazolyl, pyridyl, pyrimidinyl, pyrazinyl, pyridazinyl, triazolyl or tetrazolyl; saturated 3 to 6-membered heteromonocyclic groups containing 1 to 4 nitrogen atoms, such as pyrrolidinyl, imidazolidinyl, piperidino or piperazinyl; unsaturated condensed heterocyclic groups containing 1 to 5 nitrogen atoms, such as, indolyl, isoindolyl, indolizinyl, benzimidazolyl, quinolyl, isoquinolyl, indazolyl, benzotriazolyl or tetrazolopyridazinyl; unsaturated 3 to 6-membered heteromonocyclic group containing an oxygen atom, such as, pyranyl or furyl; unsaturated 3 to 6-membered hetermonocyclic group containing 1 to 2 sulphur atoms, such as, thienyl; unsaturated 3 to 6-membered heteromonocyclic group containing 1 to 2 oxygen atoms and 1 to 3 nitrogen atoms, such as, oxazolyl, isoazolyl or oxadiazolyl; saturated 3 to 6-membered heteromonocyclic group containing 1 to 2 oxygen atoms and 1 to 3 nitrogen atoms, such as, morpholinyl; unsaturated condensed heterocyclic group containing 1 to 2 oxygen atoms and 1 to 3 nitrogen atoms, such as, benzoxazolyl or benzoxadiazolyl; unsaturated 3 to 6-membered heteromonocyclic group containing 1 to 2 sulphur atoms and 1 to 3 nitrogen atoms, such as thiazolyl or thiadiazolyl; saturated 3 to 6-membered heteromonocyclic group containing 1 to 2 sulphur atoms and 1 to 3 nitrogen atoms, such as, thiadiazolyl; and unsaturated condensed heterocyclic group containing 1 to 2 sulphur atoms and 1 to 3 nitrogen atoms, such as benzothiazolyl or benzothiadiazolyl.

In this specification, “optionally substituted” means that a group may or may not be further substituted with one or more groups selected from oxygen, nitrogen, sulphur, alkyl, alkenyl, alkynyl, aryl, halo, haloalkyl, haloalkenyl, haloalkynyl, haloaryl, hydroxy, alkoxy, alkenyloxy, alkynyloxy, aryloxy, carboxy, benzyloxy, haloalkoxy, haloalkenyloxy, haloalkynyloxy, haloaryloxy, nitro, nitroalkyl, nitroalkenyl, nitroalkynyl, nitroaryl, nitroheterocyclyl, azido, amino, alkylamino, alkenylamino, alkynylamino, arylamino, benzylamino, acyl, alkenylacyl, alkynylacyl, arylacyl, acylamino, acyloxy, aldehydo, alkylsulphonyl, arylsulphonyl, alkylsulphonylamino, arylsulphonylamino, alkylsulphonyloxy, arylsulphonyloxy, heterocyclyl, heterocycloxy, heterocyclylamino, haloheterocyclyl, alkylsulphenyl, arylsulphenyl, carboalkoxy, carboaryloxy, mercapto, alkylthio, arylthio, acylthio and the like.

Suitable divalent linking groups for R₇ include O, S and NR₈ wherein R₈ is hydrogen or an optionally substituted straight chain, branched or cyclic, saturated or unsaturated hydrocarbon radical.

A preferred diamine chain extender is 1,3-bis(3-aminopropyl) tetramethyldisiloxane (diamine of the formula (I) wherein R₁, R₂, R₃, R₄ are methyl, R₅ and R₆ are propyl and R₇ is O) and 1,3-bis(4-aminobutyl) tetramethyldisiloxane (diamine of the formula (I) wherein R₁, R₂, R₃, R₄ are methyl, R₅ and R₆ are butyl and R₇ is O), n=1.

The diamine chain extenders may be obtained as commercially available products from Shin-Etsu in Japan or Silar Laboratories in the United States of America or prepared according to known procedures⁷.

In a preferred embodiment, the diamine of the formula (I) defined above is combined with a chain extender known in the art of polyurethane manufacture.

According to another aspect of the present invention there is provided a chain extender composition including the diamine of the formula (I) defined above and a chain extender known in the art of polyurethane manufacture.

The present invention also provides use of the composition defined above as a chain extender.

The present invention further provides the composition defined above when used as a chain extender.

The chain extender known in the art of polyurethane manufacture may be selected from diol, diamine or water chain extenders. Examples of diol chain extenders include 1,4-butanediol, 1,6-hexanediol, 1,8-octanediol, 1,9-nonanediol, 1,10-decanediol, 1,12-dodecanediol, 1,4-cyclohexanedimethanol, p-xyleneglycol and 1,4 bis(2-hydroxyethoxy) benzene. Suitable diamine chain extenders include 1,2-ethylenediamine, 1,3-propanediamine, 1,3-butanediamine and 1,6-hexanediamine.

The diamine chain extender and the known chain extender can be used in a range of molar proportions with decreasing tensile properties as the molar percentage of the diamine chain extender increases in the mixture. A preferred molar percentage of diamine chain extender is about 1 to about 50%, more preferably about 40%.

Although the preferred chain extender composition contains one conventional chain extender and one diamine chain extender, it is understood that mixtures containing more than one conventional chain extender and diamine may be used in the chain extender composition.

A preferred macrodiamine forming the soft segment of a polyurethane-urea composition is an amine-terminated PDMS, for example, bis(3-hydroxypropyl)-polydimethyl siloxane.

The macrodiamines may be obtained as commercially available products from Hulls Petrarch Systems or Shin-Etsu in Japan or prepared according to known methods⁸.

Preferably, the macrodiamine of formula (I) defined above is combined with a macrodiol and/or macrodiamine known in the art of polyurethane manufacture to form the soft segment.

According to a further aspect of the present invention there is provided a soft segment of a polyurethane-urea elastomeric composition derived from the macrodiamine of the formula (I) defined above and a macrodiol and/or a macrodiamine known in the art of polyurethane manufacture.

The present invention also provides use of the macrodiamine of the formula (I) defined above and a macrodiol and/or a macrodiamine known in the art of polyurethane manufacture in producing the soft segment of a polyurethane-urea elastomeric composition.

The present invention further provides the macrodiamine of the formula (I) defined above and a macrodiol and/or a macrodiamine known in the art of polyurethane manufacture when used in producing the soft segment of a polyurethane-urea elastomeric composition.

The macrodiol may be of any suitable type known in the art of polyurethane manufacture. Examples include polysiloxanes, polyethers, polyesters, polycarbonates or mixtures thereof.

Suitable polysiloxane macrodiols are hydroxy terminated and include those represented by the formula (II)

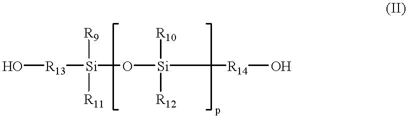

wherein

R₉, R₁₀, R₁₁, R₁₂, R₁₃ and R₁₄ are same or different and selected from an optionally substituted straight chain, branched or cyclic, saturated or unsaturated hydrocarbon radical; and

p is an integer of 1 to 100.

A preferred polysiloxane is PDMS which is a compound of formula (II) wherein R₉ to R₁₂ are methyl and R₁₃ and R₁₄ are as defined above. Preferably R₁₃ and R₁₄ are the same or different and selected from propylene, butylene, pentylene, hexylene, ethoxypropyl (—CH₂CH₂OCH₂CH₂CH₂—), propoxypropyl and butoxypropyl.

The polysiloxane macrodiols may be obtained as commercially available products such as X-22-160AS from Shin Etsu in Japan or prepared according to known procedures. The preferred molecular weight range of the polysiloxane macrodiol is about 200 to about 6000, more preferably about 500 to about 2000.

In preferred compositions the polyurethane-urea elastomeric composition are prepared from polysiloxane macrodiols and diamines.

Suitable polyether macrodiols include those represented by the formula (III)

HO—[(CH₂)_{q}—O]ᵣ—H (III)

wherein

q is an integer of 4 or more, preferably 5 to 18; and

r is an integer of 2 to 50.

In a particularly preferred embodiment, the polyurethane-urea elastomeric composition includes a soft segment derived from amine-terminated PDMS and PDMS.

Polyether macrodiols of formula (III) wherein q is 5 or higher such as poly(hexamethylene oxide) (PHMO), poly(heptamethylene oxide), poly(octamehylene oxide) (POMO) and poly(decamethylene oxide) (PDMO) are preferred over the conventional PTMO. These polyethers, due to their hydrophobic nature, are more miscible with PDMS macrodiols and yield polyurethane-ureas that are compositionally homogeneous, have high molecular weights and display improved clarity.

In another preferred embodiment, the polyurethane-urea elastomeric composition includes a soft segment derived from a macrodiamine of the formula (I) defined above and a polyether macrodiol of formula (III) defined above.

The polyether macrodiols may be prepared by the procedure described by Gunatillake et al^{6.} Polyethers such as PHMO described in this reference are more hydrophobic than PTMO and are more compatible with polysiloxane macrodiamines.

The preferred molecular weight range of the polyether macrodiol is about 200 to about 5000, more preferably about 500 to about 1200.

Suitable polycarbonate macrodiols include poly(alkylene carbonates) such as poly(hexamethylene carbonate) and poly(decamethylene carbonate); polycarbonates prepared by reacting alkylene carbonate with alkanediols for example 1,4-butanediol, 1,10-decandiol (DD), 1,6-hexanediol (HD) and/or 2,2-diethyl 1,3-propanediol (DEPD); and silicon based polycarbonates prepared by reacting alkylene carbonate with 1,3-bis(4-hydroxybutyl)-1,1,3,3-tetramethyldisiloxane (BHTD) and/or alkanediols.

It will be appreciated when both the polyether and polycarbonate macrodiols are present, they may be in the form of a mixture or a copolymer. An example of a suitable copolymer is a copoly(ether carbonate) macrodiol represented by the formula (IV)

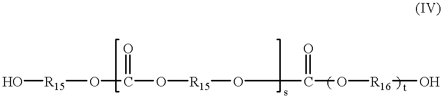

wherein

R₁₅ and R₁₆ are same or different and selected from an optionally substituted straight chain, branched or cyclic, saturated or unsaturated hydrocarbon radical; and s and t are integers of 1 to 20.

Although the compound of formula (IV) above indicates blocks of carbonate and ether groups, it will be understood that they also could be distributed randomly in the main structure.

The macrodiamines known in the art of polyurethane manufacture may include polyether macrodiamines such as POLAMINE 650 which is an amino-terminated poly(tetraethylene oxide) available from Air Products Co in the United States of America.

It will be appreciated that polyurethane-urea elastomeric compositions may also be derived from polysiloxane and polyether and/or polycarbonate macrodiols in combination with diamine chain extenders known in the art of polyurethane manufacture.

Thus, the present invention also extends to a polyurethane-urea elastomeric composition which is derived from a polysiloxane macrodiol and a polyether macrodiol and/or a polycarbonate macrodiol and a diamine chain extender known in the art of polyurethane manufacture.

The polyurethane-urea elastomeric compositions of the present invention may be prepared by any suitable known technique. A preferred method involves preparing a prepolymer by reacting the soft segment macrodiamine and/or macrodiol preferably with a diisocyanate. The initial ingredients are preferably mixed at a temperature in the range of about 45 to about 100° C., more preferably about 60 to about 80° C. If desired, a catalyst such as dibutyltin dilaurate at a level of about 0.001 to about 0.5 wt % based on the total ingredients may be added to the initial mixture. The mixing may occur in a conventional apparatus. The chain extension of the prepolymer can be carried out within the confines of a reactive extruder or continuous reactive injection-moulding machine.

The prepolymer is then dissolved in a solvent such as N,N-dimethylacetamide and the chain extender or chain extender composition is added slowly with stirring. The resulting polyurethane-urea solution may be further cured by heating at a temperature in the range of about 45 to about 100° C. The polyurethane-urea polymer can be recovered from solution by precipitating into a solvent such as methanol or water. Alternatively, the polyurethane-urea solution can be used directly for fabrication of components by the solvent casting process.

Thus, the polyurethane-urea elastomeric composition of the present invention may be further defined as including a reaction product of:

(i) the macrodiamine of the formula (I) defined above and/or a macrodiol;

(ii) a diisocyanate; and

(iii) a diamine chain extender or chain extender composition defined above and/or a chain extender known in the art of polyurethane manufacture.

The diisocyanates may be aliphatic or aromatic diisocyanates such as, for example, 4,4′-diphenylmethane diisocyanate (MDI), methylene bis (cyclohexyl) diisocyanate (H₁₂MDI), p-phenylene diisocyanate (p-PDI), trans-cyclohexane-1,4-diisocyanate (CHDI), 1,6-diisocyanatohexane (DICH), 1,5-diisocyanato naphthalene (NDI), para-tetramethylxylene diisocyanate (p-TMXDI), meta-tetramethylxylene diisocyanate (m-TMXDI), 2,4-toluene diisocyanate (2,4-TDI) or isomers or mixtures thereof or isophorone diisocyanate (IPDI). MDI is particularly preferred.

A particularly preferred polyurethane-urea elastomeric composition of the present invention includes a reaction product of:

(i) macrodiols including:

(a) polysiloxane macrodiol; and

(b) polyether macrodiol

(ii) MDI; and

(iii) a diamine chain extender as defined above or known in the art of polyurethane manufacture or a chain extender composition including a diamine chain extender and 1,3-bis(3-aminopropyl) tetramethyldisiloxane, 1,3-bis(4-aminobutyl) tetramethyldisiloxane, 1,4-butanediol, 1,2-ethylenediamine, ethanolamine, hexamethylenediamine, 1,4-butanediamine, water and/or 1,3-bis(4-hydroxybutyl) 1,1,3,3-tetramethyldisiloxane, 1,2 diaminocyclohexane, 1,3 diaminocyclohexane.

The weight ratio of polysiloxane macrodiol to polyether macrodiol in the composition may be in the range 1:99 to 99:1. A particularly preferred ratio of polysiloxane to polyether which provides a combination of good mechanical properties and degradation resistance is 80:20. Further, the preferred level of soft segment (weight percentage of the macrodiol mixture in the polyurethane-urea composition) is about 60 to about 40 wt %.

Another preferred polyurethane-urea elastomeric composition of the present invention includes a reaction product of:

(i) macrodiamines including

(a) polysiloxane macrodiamine; and

(b) polyether macrodiol or polyether macrodiamine;

(ii) MDI; and

(iii) a diamine chain extender, a chain extender known in the art of polyurethane manufacture or a chain extender composition including at least two of 1,3-bis(3-aminopropyl) tetramethyldisiloxane, 1,3-bis(4-arminobutyl) tetramethyldisiloxane, 1,4-butanediol, 1,2-ethylenediamine, ethanolamine, hexamethylenediamine, water or 1,3-bis(4-hydroxybutyl) 1,1,3,3 tetramethyldisiloxane, 1,2 diaminocyclohexane, 1,3 diaminocyclohexane.

The soft segment, diisocyanate and the chain extender or chain extender composition may be present in certain preferred proportions. The preferred level of hard segment (ie. diisocyanate and chain extender) in the composition is about 20 to 50 wt %. The weight ratio of polysiloxane to polyether in the preferred soft segment may be in the range of from 1:99 to 99:1. A particularly preferred ratio of polysiloxane to polyether which provides increased degradation resistance and improved mechanical properties is 80:20.

The polyurethane-urea elastomeric composition of the present invention is particularly useful in preparing materials having good mechanical properties, in particular biomaterials.

According to another aspect of the present invention there is provided a material having improved mechanical properties, clarity, processability and/or degradation resistance including a polyurethane-urea elastomeric composition defined above.

The present invention also provides use of the polyurethane-urea elastomeric composition defined above as a material having improved mechanical properties, clarity, processability and/or degradation resistance.

The present invention further provides the polyurethane-urea elastomeric composition defined above when used as a material having improved mechanical properties, clarity, processability and/or degradation resistance.

The mechanical properties which are improved include tensile strength, tear strength, flex fatigue resistance, abrasion resistance, Durometer hardness, flexural modulus and related measures of flexibility or elasticity.

The improved resistance to degradation includes resistance to free radical, oxidative, enzymatic and/or hydrolytic processes and to degradation when implanted as a biomaterial.

The improved processability includes ease of processing by casting such as solvent casting and by thermal means such as extrusion and injection molding, for example, low tackiness after extrusion and relative freedom from gels.

There is also provided a degradation resistant material which includes the polyurethane-urea elastomeric composition defined above.

The polyurethane-urea elastomeric composition of the present invention shows good elastomeric properties. It should also have a good compatibility and stability in biological environments, particularly when implanted in vivo for extended periods of time.

According to another aspect of the present invention there is provided an in vivo degradation resistant material which includes the polyurethane-urea elastomeric composition defined above.

The polyurethane-urea elastomeric composition may also be used as a biomaterial. The term “biomaterial” is used herein in its broadest sense and refers to a material which is used in situations where it comes into contact with the cells and/or bodily fluids of living animals or humans.

The polyurethane-urea elastomeric composition is therefore useful in manufacturing medical devices, articles or implants.

Thus, the present invention still further provides medical devices, articles or implants which are composed wholly or partly of the polyurethane-urea elastomeric composition defined above.

The medical devices, articles or implants may include cardiac pacemakers, defibrillators and other electromedical devices, catheters, cannulas, implantable prostheses, cardiac assist devices, heart valves, vascular grafts, extra-corporeal devices, artificial organs, pacemaker leads, defibrillator leads, blood pumps, balloon pumps, A-V shunts, biosensors, membranes for cell encapsulation, drug delivery devices, wound dressings, artificial joints, orthopaedic implants and soft tissue replacements.

It will be appreciated that polyurethane-urea elastomeric compositions having properties optimised for use in the construction of various medical devices, articles or implants will also have other non-medical applications. Such applications may include their use in the manufacture of artificial leather, shoe soles; cable sheathing; varnishes and coatings; structural components for pumps, vehicles, etc; mining ore screens and conveyor belts; laminating compounds, for example in glazing; textiles; separation membranes; sealants or as components of adhesives.

Thus, the present invention extends to the use of the polyurethane-urea elastomeric composition defined above in the manufacture of devices or articles.

The present invention also provides devices or articles which are composed wholly or partly of the polyurethane-urea elastomeric composition defined above.

The invention will now be described with reference to the following examples. These examples are to be construed as not limiting the invention in any way.

### EXAMPLE 1

Two polyurethane-urea compositions based on a mixture of PDMS/PHMO and a mixture of BDO and 1,3- Bis-(3-aminopropyl) tetramethyldisiloxane (BATD, from Petrarch) were prepared by a modified two-step solution polymerisation procedure. The molecular weight of PDMS for composition 1 was 1913.8 and that for composition 2 was 940.2.

Composition 1: α,ω bis-(6-hydroxyethoxypropyl) polydimethylsiloxane (PDMS, MW 1913.8 and 940.2, Shin-Etsu products KS-6001A and X-22-160AS, respectively) was dried at 105° C. under vacuum for 15 h. Poly(hexamethylene oxide) (PHMO, MW 700.2) was prepared according to a method described by Gunatillake et al⁶ and U.S. Pat. No. 5,403,912, and dried at 130° C. under vacuum for 4 h.

A mixture of dried PDMS (40.00 g) and PHMO (10.00 g) was degassed at 80° C. for 2 h under vacuum (0.1 torr) immediately prior to polymerisation. Molten MDI (24.28 g) was placed in a 1-L three-necked round bottom flask equipped with a mechanical stirrer, addition funnel, and a nitrogen inlet. The flask was then placed in an oil bath at 70° C. The degassed macrodiol mixture (50.00 g) was added dropwise through the addition funnel over a period of 30 min. After completing the addition, the reaction mixture was heated at 80° C. for 2 h with stirring under nitrogen. BDO (3.19 g) was first added to the prepolymer and stirred for 10 min. The reaction mixture was allowed to cool to ambient temperature, and anhydrous N,N-demethylacetamide (DMAc, 350 mL) was added using a syringe and stirred for about 5 min until the polymer was completely dissolved. The flask was further cooled by placing in an ice bath and BATD (5.865 g in 20 mL DMAc) was added dropwise from the addition funnel over a period of 1 h. After this, the polymer solution was slowly heated to 90° C. and allowed to react at that temperature for 3 h to complete the polymerisation.

Composition 2 was prepared similarly by reacting PDMS (MW 940.2, 40.00 g), PHMO (10.00 g MW 700.2), MDI (26.36 g), BDO (2.456 g) and BATD (4.516 g). DMAc (330 mL) was used as the solvent.

The polymer solutions, after allowing to degas, were cast as thin layers on to glass Petrie dishes. The dishes were placed in a nitrogen-circulating oven, and allowed to dry for 48 h at 45° C. Tensile and tear testing were carried out using dumbbells punched from dried polyurethane-urea films. All tests were carried out on an Instron model 4032 Universal Testing Machine. The stress relaxations of the polymers were determined by measuring the percent change in initial stress after 100 sec under an initial strain of 30%.

The properties of the two compositions are shown in Table 1.

TABLE 1
Properties of polyurethane-ureas prepared according to Example 1

| | | | | | Stress | |
|---|---|---|---|---|---|---|
| | | | | | Relax. | |
| | | | | Stress | (% | |
| | | | | @ | change | |
| | Fail | | Young's | 100% | in stress | Tear |
| | Strain | UTS | Modulus | elonga- | after | Strength |
| | (%) | (MPa) | (MPa) | tion | 100 sec) | (N/mm) |
| Composition | 370 ± | 26.6 ± | 100 ± | 14 ± | 55 | 68 ± |
| 1 | 15 | 2.0 | 16 | 1.8 | | 5.8 |
| Composition | 460 ± | 25.7 ± | 37.3 ± | 8.5 ± | 49 | 70 ± |
| 2 | 12 | 0.6 | 1.1 | .1 | | 2 |

### EXAMPLE 2

This example illustrates the preparation of a polyurethane-urea using 1,3-bis-(3-aminopropyl) tetramethyldisiloxane (BATD) as the chain extender. PDMS (MW 940.2, Shin-Etsu Product X22-160AS) and PHMO (MW 700.2) were dried using the procedures described in Example 1.

A mixture of PDMS (40.00 g) and PHMO (10.00) was degassed at 80° C. for 2 h under vacuum (0.1 torr). Molten MDI (24.16 g) was placed in a three-necked round bottom flask equipped with a mechanical stirrer, addition fimnel and nitrogen inlet. The flask was then placed in an oil bath at 70° C. The macrodiol mixture (50.00 g) was added to MDI from the addition funnel over a period of 30 min. After this the reaction mixture was heated at 80° C. for 2 h with stirring under nitrogen. DMAc (450 mL) was added to the prepolymer, and the solution cooled in ice. The chain extender BATD (9.17 g) was dissolved in DMAc (20 mL) and added to the cooled prepolymer solution over a period of about 1 h. After completing the addition, the solution was heated to 90° C. and maintained at that temperature for 2 h to complete the polymerisation. The polymer solution was allowed to degas at 60° C. in a nitrogen circulating oven, and the solution was cast to form a thin film of polymer on glass Petrie dishes. The dishes were placed in an oven at 45° C. for 48 h to evaporate the solvent DMAC.

Tensile and tear testing were carried out using dumbbells punched from dried polyurethane-urea films. All tests were carried out on an Instron model 4032 Universal Testing Machine. The stress relaxation of the polymers was determined by measuring the percent change in stress after 100 sec under an initial strain of 30%.

The polyurethane-urea exhibited 433±12% fail strain, 25.4±0.8 MPa ultimate tensile strength, 42±4 Young' modulus, 75±2.9 N/mm tear strength and a 53% stress relaxation after 100 sec.

### EXAMPLE 3

This example illustrates the preparation of polyurethane-ureas using a 40:60 (molar ratio) mixture of 1,3 bis-(4-hydroxybutyl)1,1,3,3-tetramethydisiloxane (BHTD) and ethylenediamine (EDA). Two compositions were prepared, the first using an 80:20 (w/w) mixture of PDMS (MW 940.2) and PHMO (700.2), and the second using an 80:20 (w/w) mixture of PDMS (MW 1913.3 and PHMO (700.2). The hard segment, based on MDI and BHTD/EDA, was kept constant at 40 wt % in both compositions.

Composition 1 was prepared by reacting PDMS (MW 940.2, 64.00 g), PHMO (16.00 g), MDI (42.45 g), BHTD (8.219 g) and EDA (2.663 g) according to the solution polymerisation procedure described in Example 1. The solvent used was anh. DMAc (470 mL).

Similarly, composition 2 was prepared by reacting PDMS (MW 1913.3, 40.00 g), PHMO (10.00 g), MDI (24.50 g), BHTD (6.671 g) and EDA (2.159 g). The properties of the two compositions are shown in Table 2 below.

TABLE 2
Properties of polyurethane-ureas prepared according to Example 3

| | | | | | Stress | |
|---|---|---|---|---|---|---|
| | | | | | Relax. | |
| | | | | Stress | (% | |
| | | | | @ | change | |
| | Fail | | Young's | 100% | in stress | Tear |
| | Strain | UTS | Modulus | elonga- | after | Strength |
| | (%) | (MPa) | (MPa) | tion | 100 sec) | (N/mm) |
| Composition | 450 ± | 29 ± | 40 ± | 12 ± | 29 | 77 ± |
| 1 | 15 | 0.8 | 6.3 | 0.3 | | 3 |
| Composition | 360 ± | 29 ± | 95 ± | 18 ± | 31 | 66 ± |
| 2 | 22 | 3.9 | 11 | 1.3 | | 8 |

### EXAMPLE 4

This example illustrates the preparation of two compositions based on chain extender mixtures of ethylenediamine (EDA) and H₂O (60:40 mol/mol), and ethanolamine (EA) and BHTD (60:40 mol/mol), respectively for compositions 1 and 2. In the first composition, the soft segment was based on an 80:20 (wt/wt) mixture of PDMS (MW 940.2) and PHMO (MW 700.2), and the diisocyanate was MDI. The second composition was based on an 80:20 (wt/wt) mixture of PDMS and PTMO (MW 1980.8), and the diisocyanate was MDI. The hard segment weight percentage was kept constant at 40 in both compositions. PHMO, PTMO and PDMS were dried according to procedures described in Example 1.

Composition 1 was prepared by reacting PDMS (MW 940.2, 40.00 g), PHMO (MW 700.2, 10.00 g), MDI (30.65 g), EDA (2.241 g) and H₂O (0.447 g) according to the solution polymerisation procedure described in Example 1. Anh. DMAc (335 mL) was used as the solvent.

Similarly, composition 2 was prepared by reacting PDMS (MW 940.2, 40.00 g), PTMO (MW 1980.8, 10.00 g), MDI (25.64 g), BHTD (5.783 g) and EDA (1.902 g) according to the solution polymerisation procedure described in Example 1. The solvent used was anh. DMAc (335 mL). The properties of the two polyurethane-urea compositions are shown in Table 3.

TABLE 3
Properties of polyurethane-ureas prepared according to Example 4

| | | | | | Stress | |
|---|---|---|---|---|---|---|
| | | | | | Relax. | |
| | | | | Stress | (% | |
| | | | | @ | change | |
| | Fail | | Young's | 100% | in stress | Tear |
| | Strain | UTS | Modulus | elonga- | after | Strength |
| | (%) | (MPa) | (MPa) | tion | 100 sec) | (N/mm) |
| Composition | 340 ± | 32 ± | 100 ± | 18 ± | 42 | 74 ± |
| 1 | 34 | 4.8 | 21 | 2.9 | | 0.9 |
| Composition | 450 ± | 29 ± | 57 ± | 10 ± | 25 | 59 ± |
| 2 | 32 | 0.6 | 4.5 | 0.3 | | 3.7 |

### EXAMPLE 5

This example illustrates the use of a macrodiamine to form part of the soft segment in a polyurethane-urea composition.

Aminopropyl-terminated polydimethylsiloxane (PS 510, MW 2507.1, from Hülls Petrarch Systems) was used. PHMO (MW 700.2) was dried according to the procedure described in Example 1.

Molten MDI (11.67 g) was placed in a 500 mL three-necked flask round bottom flask equipped with a mechanical stirrer, addition funnel and a nitrogen inlet, and the flask was placed in an oil bath at 70° C. The degassed BHTD (3.361 g) was added to MDI over a period of 20 min with stirring. Anhydrous DMAc solvent (50 mL) was then added using a syringe to dissolve the reaction mixture. This was followed by adding BDO (1.631 g) and the reaction was allowed to occur for 30 min. The solution was allowed to cool to ambient temperature after adding more DMAc (110 mL). The PHMO/amino-PDMS mixture (25.00 g in 20/80 wt/wt ratio) was then added to the solution in flask over a period of 45 min. The reaction mixture was heated to 90° C. and allowed to react for 3 h to complete the polymerisation.

A 0.5 mm film of the polymer was cast from solution using the procedure described in Example 1. The polyurethane-urea exhibited 24±2 MPa ultimate tensile strength, 133±9 fail strain, 19.4±4 MPa stress at 100% strain, and 58±5 tear strength.

### EXAMPLE 6

This example illustrates the preparation of polyurethane-urea compositions based on a mixture of PDMS and polyether macrodiols using a conventional diamine chain extender. PDMS (MW 1913.8, Shin-Etsu product KS-6001A), PTMO (Terethane®, MW 3106.8) and PHMO (MW 700.2) were purified according to procedures described in example 1.

Composition 1 was a mixture of PDMS (40.00 g) and PTMO (10.00) was degassed at 80° C. for 2 h under vacuum (0.1 torr). Molten MDI (12.07 g) was placed in a three-necked round bottom flask equipped with a mechanical stirrer, addition funnel and nitrogen inlet. The flask was then placed in an oil bath at 70° C. The macrodiol mixture (50.00 g) was added to MDI from the addition funnel over a period of 30 min. After this the reaction mixture was heated at 80° C. for 2 h with stirring under nitrogen. DMAc (340 mL) was added to the prepolymer, and the solution cooled in ice. The chain extender ethylenediamine (1.45 g) was dissolved in DMAc (20 mL) and added to the cooled prepolymer solution over a period of about 1 h. After completing the addition, the solution was heated to 90° C. and maintained at that temperature for 2 h to complete the polymerisation. The polymer solution was allowed to degas at 60° C. in a nitrogen circulating oven, and the solution was cast to form a thin film of polymer on glass Petrie dishes. The dishes were placed in an oven at 45° C. for 48 h to evaporate the solvent DMAC.

Similarly, composition 2 was prepared by reacting PDMS (MW 1913.8, 20.00 g), PHMO (MW 700.2, 5.00 g), MDI (8.80 g), and EDA (1.057 g). DMAc (200 mL) was used as the solvent.

The properties of the two polyurethane-urea compositions are shown in Table 4.

TABLE 4
Properties of polyurethane-ureas prepared according to Example 6

| | | | | | Stress | |
|---|---|---|---|---|---|---|
| | | | | | Relax. | |
| | | | | Stress | (% | |
| | | | | @ | change | |
| | Fail | | Young's | 100% | in stress | Tear |
| | Strain | UTS | Modulus | elonga- | after | Strength |
| | (%) | (MPa) | (MPa) | tion | 100 sec) | (N/mm) |
| Composition | 388 ± | 16 ± | 28 ± | 8.7 ± | 26 | 68 |
| 1 | 73 | 1.4 | 0.8 | .3 | | |
| Composition | 290 ± | 16 ± | 25 ± | 10 ± | 27 | 68 ± |
| 2 | 32 | 2.6 | 4 | 1 | | 8 |

### EXAMPLE 7

This example illustrates the preparation of a polyurethane-urea based on a mixture of PDMS/PHMO, MDI and a mixture of 1,2-ethylenediamine and water (H₂O) as chain extenders.

A mixture of PDMS (60.00 g, MW 1894.97, Shin-Etsu product KS 6001A) and PHMO (15.00 g, MW 688.89) was degassed at 80° C. for 2 h under vacuum (0.1 torr). Molten MDI (32.20 g) was placed in a three-necked flask equipped with mechanical stirrer, addition funnel and a nitrogen inlet. The flask was then placed in an oil bath at 70° C. The degassed macrodiol mixture (75.00 g) was added through the addition funnel over a period of 30 min. After the addition was over, the reaction mixture was heated at 80° C. for 2 h with stirring under nitrogen. The reaction mixture was cooled to room temperature and anhydrous N′N-dimethylacetamide (DMAc, 540 mL) was added through a syringe to the reaction mixture and stirred for 5 minutes to dissolve the prepolymer. The solution was further cooled in an ice bath to 0° C. and EDA (2.58 g) dissolved in anhydrous DMAc (20 mL) was added drop wise into prepolymer solution over a period of 1 h. After the addition was over, H₂O (0.51 g) was quickly added to the polymer solution and heated to 90° C. for a period of 3 h. The polymer solution was filtered through a polypropylene filter bag to remove any gel particles. The solution was then degassed by warming to 60° C. and cast a film (˜0.5 mm) by pouring the solution on to a Petrie dish and allowing the solvent to evaporate in a nitrogen-circulating oven at 50° C. The film was dried for 48 h at 60° C. under vacuum (0.1 torr) to remove remaining DMAc before punching dumbbells for tensile testing.

The polyurethane-urea exhibited 23.6±1 MPa ultimate tensile strength, 294±15% fail strain, 26.9±3.8 MPa Young's modulus and 78.9±6.0 N/mm tear strength.

### EXAMPLE 8

This example illustrates the use of water as a chain extender.

A mixture of PDMS (60.00 g, MW 1897.93, Shin-Etsu product KS 6001A) and PHMO (15.00 g, MW 688.89) was degassed at 80° C. for 2 h under vacuum (0.1 torr). Molten MDI (26.72 g) was placed in a three-necked flask equipped with mechanical stirrer, addition funnel and a nitrogen inlet. The flask was then placed in an oil bath at 70° C. The degassed macrodiol mixture (75.00 g) was added from the addition funnel over a period of 30 min. After the addition was over, the reaction mixture was heated at 80° C. for 2 h with stirring under nitrogen. The reaction mixture was cooled to room temperature and anhydrous DMAc (325 mL) was added through a syringe to the reaction mixture and stirred for 5 minutes to dissolve the prepolymer. H₂O (0.960 g) dissolved in anhydrous DMAc (20 mL) was added drop wise into prepolymer solution. After the addition was over, the solution was heated to 90° C. for a period of 4 h. A thin film (˜0.5 mm) of the polymer was cast using the procedure described in Example 7.

The polyurethane-urea exhibited 9.7±0.3 MPa ultimate tensile strength, 366±5% fail strain, 12.8±0.7 MPa Young's modulus and 47.5±2.3 N/mm tear strength.

### EXAMPLE 9

This example illustrates the preparation of polyurethane-urea with low hard segment content (32 wt-%) using a mixture of 1,2-ethylenediamine and 1,3-bis(4-hydroxybutyl)-1,1,3,3-tetramethyldisiloxane (BHTD).

A mixture of PDMS (60.00 g, MW 1897.93, Shin-Etsu product KS 6001A) and PHMO (15.00 g, MW 688.894) was degassed at 80° C. for 2 h under vacuum (0.1 torr). Molten MDI (27.41 g) was placed in a three-necked flask equipped with mechanical stirrer, addition funnel and a nitrogen inlet. The flask was then placed in an oil bath at 70° C. The degassed macrodiol mixture (75.00 g) was added from the addition funnel over a period of 30 min. After the addition was over, the reaction mixture was heated at 80° C. for 2 h with stirring under nitrogen. BHTD (5.98 g) was added to prepolymer solution and reaction continued for 30 min at 80° C. The reaction mixture was cooled to room temperature and anhydrous DMAc (550 mL) was added from a syringe to the reaction mixture and stirred to dissolve the prepolymer. The solution was further cooled in an ice bath to 0° C., and EDA (1.91 g) dissolved in anhydrous DMAc (50 mL) was added over a period of 1 h. The polymer solution was then heated to 90° C. for 3 h. The polymer solution was degassed by warming to 60° C. and cast a film (˜0.5mm) using the procedure described in Example 7 for tensile testing.

The polyurethane-urea exhibited the following properties; 20.2±1 MPa ultimate tensile strength, 443±18% fail strain, 11.1±0.3 MPa Young's modulus, 6.6±0.1 MPa stress at 100% elongation, and 57.7±5 N/mm tear strength.

### EXAMPLE 10

This example illustrates the preparation of a polyurethane-urea with low hard segment weight content (22 wt-%) using 1,2-ethylenediamine as the chain extender

A mixture of PDMS (70.00 g, MW 1894.97, Shin-Etsu product KS 6001A) and PHMO (17.50 g, MW 688.89) was degassed at 80° C. for 2 h under vacuum (0.1 torr). Molten MDI (23.05 g) was placed in a three-necked flask equipped with mechanical stirrer, addition funnel and a nitrogen inlet. The flask was placed in an oil bath at 70° C. The degassed macrodiol mixture (77.50 g) was added to MDI from the addition funnel over a period of 30 min. After the addition was over, the reaction mixture was heated at 80° C. for 2 h with stirring under nitrogen. The reaction mixture was cooled to room temperature and anhydrous DMAc (500 ML) was added through a syringe to the reaction mixture and stirred for 5 minutes to dissolve the prepolymer. The solution was further cooled in an ice bath to 0° C. and EDA (1.63 g) mixed with anhydrous DMAc (50 mL) was added into above solution over a period of 1 h. The polymer solution was then heated to 90° C. for a period of 3 h. The polymer solution was then degassed by warming to 60° C. and cast a film (˜0.5 mm) using the procedure described in Example 7 for tensile testing.

The polyurethane-urea exhibited 14±0.2 MPa ultimate tensile strength, 412±9% fail strain, 8.3±0.2 MPa Young's modulus, 5.6±0.08 MPa stress @100% elongation and 53.4±2.7 N/mm Tear Strength.

### EXAMPLE 11

This example illustrates the preparation of a polyurethane-urea using a mixture of amine chain extenders and a chain terminator.

A mixture of PDMS (40.00 g, MW 1894.97, Shin-Etsu product KS 6001 A) and PHMO (10.00 g, MW 688.894) was degassed at 80° C. for 2 h under vacuum (0.1 torr). Molten MDI (15.157 g) was placed in a three-necked flask equipped with mechanical stirrer, dropping funnel and a nitrogen inlet. The flask was then placed in an oil bath at 70° C. The degassed macrodiol mixture (50.00 g) was added quickly through the addition funnel and the reaction mixture was heated at 80° C. for 2 h with stirring under nitrogen. The reaction mixture was cooled to room temperature and anhydrous DMAc (100 mL) was added through a syringe to the reaction mixture and stirred for 5 minutes to dissolve the prepolymer. The solution was further cooled in an ice bath to 0° C. A mixture of EDA (1.198-g), 1,2-Diaminocyclohexane (0.567 g) and diethylamine (0.1276 g) mixed in anhydrous DMAc (60 mL) was added quickly into prepolymer solution with vigorous stirring. Afterwards, the polymer solution was warmed to 100° C. and kept at that temperature to complete the polymerisation.

A thin film (0.5 mm) of the polymer was cast using the procedure described in Example 7.

The polyurethane-urea exhibited 10.6±0.2 MPa ultimate tensile strength, 234±14% fail strain, 27.3±2 MPa Young's modulus, 7.8±0.09 MPa stress @100% elongation 33.7±6.7 N/mm tear strength.

### EXAMPLE 12

This example illustrates the preparation of a polyurethane-urea using a mixture of higher molecular weight PDMS (MW 3326.11) and PTMO (MW 1974.96).

A mixture of PDMS (60.00 g, MW 3326.11, Shin-Etsu product KS 6002) and PTMO (15.00 g, MW 1974.96) was degassed at 80° C. for 2 h under vacuum (0.1 torr). Molten MDI (18.40 g) was placed in a three-necked flask equipped with mechanical stirrer, addition fimnel and a nitrogen inlet. The flask was then placed in an oil bath at 70° C. The degassed macrodiol mixture (75.00 g) was added quickly through the addition funnel and the reaction mixture was heated at 80° C. for 2 h with stirring under nitrogen. The reaction mixture was cooled to room temperature and anhydrous DMAc and dioxane (50/50) (1500 mL) was added to the reaction mixture and stirred to dissolve the prepolymer. The solution was further cooled in an ice bath to 0° C. and EDA (2.75 g), mixed with anhydrous DMAc (100 mL) was added to prepolymer solution with stirring over a period of 1 h. The polymer solution was further diluted (˜5%) and heated to about 90° C. to break gels and filtered to remove gels.

A thin film (˜0.5 mm) of the polymer was cast from the filtered polymer solution using the procedure described in Example 7.

The polyurethane-urea exhibited 23.3±0.8 MPa ultimate tensile strength, 463±15% fail strain, 31.9±2 MPa Young's modulus, 9.3±0.09 MPa stress @100% elongation.

### EXAMPLE 13

The in-vivo degradation resistance of polyurethane-ureas prepared in examples 1,2,3,4,5, and 6 was tested by a three month ovine implant experiment. Pellethane™ 2363-80 A and 2363-55D were used as positive and negative controls, respectively. A laboratory synthesised polyurethane-urea was used as a third control to represent a polyurethane-urea based on conventional polyether macrodiol PTMO, MDI and a conventional diamine chain extender 1,2-ethylenediamine. This polyurethane-urea (control polyurethane-urea) was prepared by reacting PTMO (120.0 g MW 1980.7), MDI (30.324 g) and EDA (3.641 g) in DMAc (1400 mL) using the two-step solution polymerisation procedure described in Example 7.

Each polyurethane composition and commercial materials Pellethane™ 2363-80 A and 2363-55D was formed, by solvent casting, into sheets of 0.5 mm thickness using the procedure described in Example 7. Specimens shaped as dumbbells were cut from the sheets and stretched over poly(methyl methacrylate) holders. This caused the central section to be strained to 250% of its original length. A polypropylene suture was firmly tied around the centre of each specimen. This caused a localised increase in stress in the specimen. This test method provides a means of assessing the resistance to stress-induced biodegradation.

The specimens attached to their holders were sterilised with ethylene oxide and implanted into the subcutaneous adipose tissue in the dorsal thoraco-lumbar region of adult crossbred wether sheep. After a period of three months the polyurethanes were retrieved. Attached tissue was carefully dissected away and the specimens were washed by soaking in 0.1 M sodium hydroxide for 2 days at ambient temperature followed by rinsing in deionised water. The specimens were then dried in air and examined by scanning electron microscopy (SEM).

A standard set of SEM images was taken at 5 equidistant sites within a 15 mm length on each specimen and at various magnifications for both explanted specimens and unimplanted reference samples. The magnifications ranged from a 10× overview up to several 500× images. When image collection was completed these data were recorded in forms and used in conjunction with the SEM images to score each image. Each image was scored individually by registering the weighted score, if obvious degradation-related surface features could be distinguished in that image. If there was no degradation a score of zero (0) was registered for that image. After all images of one specimen have been scored a total rating for that specimen was calculated as the aggregate of these individual scores. Specimens were rated between 0 and 50, with 50 being scored for a fractured (automatic score of 50) or highly degraded sample where all images showed obvious signs of degradation. SEM micrographs were rated by two independent examiners and a mean rank was assigned to each sample. The results are summarised in Table 5.

The results clearly demonstrated that the positive controls Pellethane 80A and the laboratory synthesised polyurethane-urea were severely degraded in this study. The polyurethane-urea compositions prepared according to the present invention showed better resistance to degradation than the control materials as illustrated by the results shown in Table 5.

TABLE 5
SEM ranks of experimental polyurethane-ureas and control materials
based on SEM examination of explanted test specimens.

| | |
|---|---|
| | Rank |
| Sample | Mean (Std Dev) |

controls

| | |
|---|---|
| Pellethane 2363-80A | 40.9 ± 7.9 |
| P55D | 3.2 ± 5.0 |
| Laboratory synthesised polyurethane-urea | 50 ± 0 |
| control | |

polyurethane-ureas according to this invention

| | |
|---|---|
| Example 2 | 2.4 ± 3.3 |
| Example 3, composition 1 | 17.1 ± 9.6 |
| Example 4, composition 2 | 0.7 ± 1.2 |
| Example 4, composition 1 | 10.6 ± 5.7 |
| Example 6, composition 2 | 18.4 ± 10.5 |
| Example 1, composition 2 | 4.5 ± 6.7 |
| Example 1, composition 1 | 3.6 ± 4.4 |
| Example 5 | 24.9 ± 14 |

Notes: A rank of 0 indicates no degradation observable in any of the SEM images (up to 500 X magnification) while a rank of 50 indicates severe degradation and signs of degradation were observed in all SEM images.

### EXAMPLE 14

This example illustrates the cyclic flex-fatigue resistance of new polyurethane-ureas compositions. The polyurethane-urea composition 2 prepared according to procedure described in Example 3 was used in this experiment. The valves were prepared by dip-forming from the polyurethane-urea solution in DMAc (approx. 25-wt %) onto a valve frame fabricated from poly(ether ether ketone) (PEEK) under nitrogen at 65° C. Two valves were prepared with mean valve leaflet thickness of 110 and 48 p. The valves were tested in the valve fatigue tester (Rowan Ash fatigue tester) at 37° C.

The two valves have so far completed 295 million cycles (110μ thick valve) and 343 million cycles (48μ thick valve) without failure indicating the very high cyclic flex-fatigue resistance of the new polyurethane-urea.

### REFERENCES

1. B. J. Tyler, B. D. Ratner, D. G. Castner and D. Briggs, J. Biomed. Mater. Res., 26, 273 (1992).

2. M. Szycher, and W. A. McArthur, Surface Fissuring of Polyurethanes Following In-Vivo Exposure, In A. C. Fraker and C. D. Griffin, Eds. Corrosion and Degradation of Implant Materials, Philadelphia, Pa., ASTM STP 859, 308-321 (1985).

3. S. J. McCarthy, G. F. Meijs, N. Mitchell, P. A. Gunatillake, G. Heath, A. Brandwood, and K. Schindhelm, Biomaterials, 18, 1387 (1997).

4. L. Pinchuk, J. Biomater. Sci. Edn, Vol 3 (3), pp 225-267 (1994).

5. I. Yilgör, J. S. Riffle, W. P. Steckle, Jr., A. K. Banthia and J. E. McGrath, Polym. Mater. Sci & Eng. Vol 50, pp 518-522 (1984).

6. P. A. Gunatillake, G. F. Meijs, R. C. Chatelier, D. M. McIntosh and E. Rizzardo Polym. Int. Vol 27, pp 275-283 (1992).

7. J. C. Saan and J. L. Speier, J Org Chem, 24,119(1959).

8. X. H. Yu, M. R. Nagarajan, T. G. Grasel, P. E. Gibson, and S. L. Cooper, J Poly Sci Polym Phys, 23, 2319-2338 (1985)

1. A polyurethane-urea elastomeric composition which is derived from a silicon-containing diamine of the formula (I): 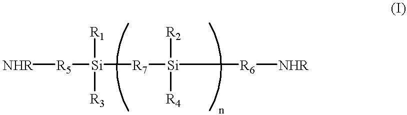
wherein
R is hydrogen or an optionally substituted straight chain, branched or cyclic, saturated or unsaturated hydrocarbon radical;
R₁, R₂, R₃, R₄, R₅ and R₆ are the same or different and selected from hydrogen or an optionally substituted straight chain, branched or cyclic, saturated or unsaturated hydrocarbon radical;
R₇ is a divalent linking group or an optionally substituted straight chain, branched or cyclic, saturated or unsaturated hydrocarbon radical; and
n is an integer of 1 or greater:

2. A polyurethane-urea elastomeric composition according to claim 1 wherein the diamine of the formula (I) functions as chain extender when n is 1 to 4 for molecular weights of about 500 or less.

3. A polyurethane-urea elastomeric composition according to claim 1 wherein the diamine of the formula (I) functions as a macrodiamine to form the soft segment of a polyurethane-urea composition when n is 5 to 100 for molecular weights of about 500 to about 10,000.

4. A polyurethane-urea elastomeric composition according to any one of claims 1 to 3 wherein the diamine of the formula (I) is used in combination with other chain extenders, macrodiols and/or macrodiamines.

5. Use of the diamine of the formula (I) defined in claim 1 in producing a polyurethane-urea elastomeric composition.

6. The diamine of the formula (I) defined in claim 1 when used in producing a polyurethane-urea elastomeric composition.

7. A chain extender including the diamine of the formula (I) defined in claim 1.

8. A chain extender according to claim 7 wherein the diamine of formula (I) has a molecular weight range of about 60 to about 500.

9. A chain extender according to claim 7 or claim 8 wherein the diamine of formula (I) has a molecular weight range of about 60 to about 450.

10. A chain extender according to any one of in claims 7 to 9 wherein the diamine of the formula (I) is 1,3-bis(3-aminopropyl) tetramethyldisiloxane (R₁, R₂, R₃, R₄ are methyl, R₅ and R₆ are propyl and R₇ is O) or 1,3-bis(4-aminobutyl) tetramethyldisiloxane (R₁, R₂, R₃, R₄ are methyl, R₅ and R₆ are butyl and R₇ is O).

11. A chain extender according to any one of claims 7 to 10 wherein the diamine of the formula (I) is combined with a chain extender known in the art of polyurethane manufacture.

12. A chain extender according to claim 11 wherein the chain extender known in the art of polyurethane manufacture is a diol, diamine or water chain extender.

13. A chain extender according to claim 12 wherein the diol chain extender is 1,4-butanediol, 1,6-hexanediol, 1,8-octanediol, 1,9-nonanediol, 1,10-decanediol, 1,12-dodecanediol, 1,4-cyclohexanedimethanol, p-xyleneglycol, 1,4 bis(2-hydroxyethoxy) benzene or water.

14. A chain extender according to claim 12 wherein the diamine chain extender is 1,2-ethylenediamine, 1,3-propanediamine, 1,3-butanediamine, 1,6-hexanediamine., 1,2-diaminocyclohexane, 1,3-diaminocycloexane.

15. A chain extender according to any one of claims 11 to 14 wherein the molar percentage of diamine chain extender is about 1 to about 50%.

16. A chain extender according to any one of claims 11 to 15 wherein the molar percentage of diamine chain extender is about 40%.

17. Use of the diamine of the formula (I) defined in claim 1 as a chain extender.

18. The diamine of the formula (I) defined in claim 1 when used as a chain extender.

19. A soft segment of a polyurethane-urea elastomeric composition derived from the diamine of the formula (I) defined in claim 1.

20. A soft segment of a polyurethane-urea composition according to claim 19 wherein the diamine of the formula (I) is an amine-terminated PDMS.

21. A soft segment of a polyurethane-urea composition according to claim 20 wherein the amine-terminated PDMS is bis(3-hydroxypropyl)-polydimethyl siloxane.

22. A soft segment of a polyurethane-urea composition according to claims 19 to 21 wherein the diamine of formula (I) is combined with a macrodiol and/or macrodiamine known in the art of polyurethane manufacture.

23. A soft segment of a polyurethane-urea composition according to claim 22 wherein the macrodiol is a polysiloxane, polyether, polyester, polycarbonate or mixtures thereof.

24. A soft segment of a polyurethane-urea composition wherein the polysiloxane macrodiol is hydroxy terminated and represented by the formula (II) 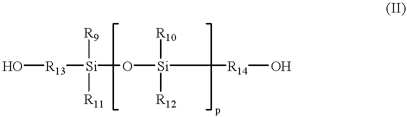
wherein
R₉, R₁₀, R₁₁, R₁₂, R₁₃ and R₁₄ are same or different and selected from an optionally substituted straight chain, branched or cyclic, saturated or unsaturated hydrocarbon radical; and
p is an integer of 1 to 100.

25. A soft segment of a polyurethane-urea composition according to claim 24 wherein the polysiloxane macrodiol is PDMS (compound of formula (II) wherein R₉ to R₁₂ are methyl and R₁₃ and R₁₄ are as defined in claim 24).

26. A soft segment of a polyurethane-urea composition according to claim 25 wherein R₁₃ and R₁₄ are the same or different and selected from propylene, butylene, pentylene, hexylene, ethoxypropyl (—CH₂CH₂OCH₂CH₂CH₂—), propoxypropyl or butoxypropyl.

27. A soft segment of a polyurethane-urea composition according to any one of claims 23 to 26 wherein the molecular weight range of the polysiloxane macrodiol is about 200 to about 6000.

28. A soft segment of a polyurethane-urea composition according to claim 27 wherein the molecular weight range of the polysiloxane macrodiol is about 500 to about 2000.

29. A soft segment of a polyurethane-urea composition according to any one of claims 22 to 28 which is derived from amine-tenninated PDMS and PDMS.

30. A soft segment of a polyurethane-urea composition according to claim 23 wherein the polyether macrodiol is represented by the formula (III)
HO—[(CH₂)_{q}—O]ᵣ—H (III)
wherein
q is an integer of 4 or more; and
r is an integer of 2 to 50.

31. A soft segment defined in claim 30 wherein the polyether macrodiol of formula (III) has q is 5 or higher.

32. A soft segment defined in claim 31 wherein the polyether macrodiol is poly(hexamethylene oxide) (PHMO), poly(heptamethylene oxide), poly(octamethylene oxide) (POMO) or poly(decamethylene oxide) (PDMO).

33. A soft segment of a polyurethane-urea composition according to any one of claims 30 to 32 derived from a macrodiamine of the formula (I) defined in claim 1 and a polyether macrodiol of formula (III) defined in claim 30.

34. A soft segment of a polyurethane-urea composition according to claims 23 to 33 wherein the molecular weight range of the polyether macrodiol is about 200 to about 5000.

35. A soft segment defined in claim 34 wherein the molecular weight range of the polyether macrodiol is about 500 to about 1200.

36. A soft segment of a polyurethane-urea composition according to any one of claims 23 to 35 wherein the polycarbonate macrodiol is a poly(alkylene carbonate), polycarbonates prepared by reacting alkylene carbonate with alkanediols or silicon based polycarbonates prepared by reacting alkylene carbonate with 1,3-bis(4-hydroxybutyl)-1,1,3,3-tetramethyldisiloxane (BHTD) and/or alkanediols.

37. A soft segment of a polyurethane-urea composition according to any one of claims 23 to 36 wherein both the polyether and polycarbonate macrodiols are present and are in the form of a mixture or a copolymer.

38. A soft segment of a polyurethane-urea composition according to claim 37 wherein the copolymer is a copoly(ether carbonate) macrodiol represented by the formula (IV) 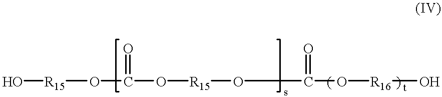
wherein
R₁₅ and R₁₆ are same or different and selected from an optionally substituted straight chain, branched or cyclic, saturated or unsaturated hydrocarbon radical; and s and t are integers of 1 to 20.

39. A soft segment of a polyurethane-urea composition according to any one of claims 22 to 38 wherein the macrodiamine known in the art of polyurethane manufacture is a polyether macrodiamine.

40. A soft segment of a polyurethane-urea composition according to claim 39 wherein the polyether macrodiamine is POLAMINE 650 which is an amino-terminated poly(tetramethylene oxide).

41. Use of the diamine of the formula (I) defined in claim 1 in producing the soft segment of a polyurethane-urea elastomeric composition.

42. The diamine of the formula (I) defined in claim 1 when used in producing the soft segment of a polyurethane-urea elastomeric composition.

43. A polyurethane-urea elastomeric composition which is derived from a polysiloxane macrodiol and a polyether macrodiol and/or a polycarbonate macrodiol and a diamine chain extender known in the art of polyurethane manufacture.

44. A polyurethane-urea elastomeric composition including a reaction product of:
(i) the macrodiamine of the formula (I) defined in claim 1 and/or a macrodiol;
(ii) a diisocyanate; and
(iii) a diamine chain extender or chain extender composition defined in any one of claims 7 to 16 and/or a chain extender known in the art of polyurethane manufacture.

45. A polyurethane-urea elastomeric composition according to claim 44 wherein the diisocyanate is aliphatic or aromatic

46. A polyurethane-urea elastomeric composition according to claim 44 or 45 wherein the diisocyanate is 4,4′-diphenylmethane diisocyanate (MDI), methylene bis (cyclohexyl) diisocyanate (H₁₂MDI), p-phenylene diisocyanate (p-PDI), trans-cyclohexane-1,4diisocyanate (CHDI), 1,6-diisocyanatohexane (DICH), 1,5-diisocyanato naphthalene (NDI), para-tetramethylxylene diisocyanate (p-TMXDI), meta-tetramethylxylene diisocyanate (m-TMXDI), 2,4-toluene diisocyanate (2,4-TDI) or isophorone diisocyanate (IPDI) or isomers or mixtures thereof.

47. A polyurethane-urea elastomeric composition according to any one of claims 44 to 46 including a reaction product of:
(i) macrodiols including:
polysiloxane macrodiol; and
polyether macrodiol
(ii) MDI; and
(iii) a diamine chain extender as defined in any one of claims 7 to 10 or known in the art of polyurethane manufacture or a chain extender composition including a diamine chain extender and 1,3-bis(3-aminopropyl) tetramethyldisiloxane, 1,3-bis(4-aminobutyl) tetramethyldisiloxane, 1,4-butanediol, 1,2-ethylenediamine, ethanolamine, hexamethylenediamine, 1,4-butanediamine, water and/or 1,4-bis(4-hydroxybutyl) tetramethyldisiloxane.

48. A polyurethane-urea elastomeric composition according to claim 47 wherein the weight ratio of polysiloxane macrodiol to polyether macrodiol in the composition is in the range of 1:99 to 99:1.

49. A polyurethane-urea elastomeric composition according to claim 47 or claim 48 wherein the weight ratio of polysiloxane to polyether is 80:20.

50. A polyurethane-urea elastomeric composition according to any one of claims 44 to 49 wherein the weight level of soft segment (weight percentage of the macrodiol mixture in the polyurethane-urea composition) is about 60 to about 40 wt %.

51. A polyurethane-urea elastomeric composition which includes a reaction product of:
(i) macrodiamines including
polysiloxane macrodiamine; and
polyether macrodiol or polyether macrodiamine;
(ii) MDI; and
(iii) a diamine chain extender, a chain extender known in the art of polyurethane manufacture or a chain extender composition including at least two of 1,3-bis(3-aminopropyl) tetramethyldisiloxane, 1,3-bis(4-aminobutyl) tetramethyldisiloxane, 1,4-butanediol, 1,2-ethylenediamine, ethanolamine, hexamethylenediamine, 1,3-diaminocyclohexane, 1,2-diamino cyclohexane, water or 1,3-bis(4-hydroxybutyl) 1,1,3,3- tetramethyldisiloxane.

52. A polyurethane-urea elastomeric composition according to claim S wherein the level of hard segment (diisocyanate and chain extender) in the composition is about 15 to 50 wt %.

53. A polysiloxane polyurethane-urea elastomer composition including a reaction product of:
(i) macrodiol selected from the group consisting of polysiloxane macrodiols, polyether macrodiols, polycarbonate macrodiols and mixtures thereof.
(ii) MDI; and
(iii) a chain extender selected from diamines, diols and water.

54. A material having improved mechanical properties, clarity, processability and/or degradation resistance including the polyurethane-urea elastomeric composition defined in any one of claims 1 to 4 and 43 to 53.

55. A material resistant to cyclic flex fatigue which includes the polyurethane-urea composition defined in any one of claims 1 to 4 and 43-55.

56. A degradation resistant material which includes the polyurethane-urea elastomeric composition defined in any one of claims 1 to 4 and 43 to 53.

57. An in vivo degradation resistant material which includes the polyurethane-urea elastomeric composition defined in any one of claims 1 to 4 and 43 to 53.

58. A biomaterial which includes the polyurethane-urea elastomeric composition defined in any one of claims 1 to 4 and 43 to 53.

59. Medical devices, articles or implants which are composed wholly or partly of the polyurethane-urea elastomeric composition defined in any one of claims 1 to 4 and 43 to 53.

60. Medical devices, articles or implants according to claim 59 which are cardiac pacemakers, defibrillators and other electromedical devices, catheters, cannulas, implantable prostheses, cardiac assist devices, heart valves, vein valves, vascular grafts, extra-corporeal devices, artificial organs, pacemaker leads, defibrillator leads, blood pumps, balloon pumps, A-V shunts, biosensors, membranes for cell encapsulation, drug delivery devices, wound dressings, artificial joints, orthopaedic implants and soft tissue replacements.

61. Devices or articles which are composed wholly or partly of the polyurethane-urea elastomeric composition defined in any one of claims 1 to 4 and 43 to 53.

62. Devices or articles according to claim 61 which are artificial leather, shoe soles; cable sheathing; varnishes and coatings; structural components for pumps, vehicles, etc; mining ore screens and conveyor belts; laminating compounds, textiles; separation membranes; sealants or components of adhesives.
